(19) United States
(12) Patent Application Publication
(10) Pub. No.: US 2019/0386504 A1
(43) Pub. Date: Dec. 19, 2019

(54) ENERGY HARVESTING POWER SYSTEM

(71) Applicant: Analog Devices Global Unlimited Company, Hamilton (BM)

(72) Inventors: Suyi YAO, Shanghai (CN); Yanfeng Lu, Shanghai (CN); Ruo Mo, Shanghai (CN)

(21) Appl. No.: 16/011,450

(22) Filed: Jun. 18, 2018

(51) Int. Cl. H02J 7/00; H02J 3/38; H02J 9/06

(52) U.S. Cl. CPC H02J 7/0068; H02M 7/06; H02J 9/061; H02J 3/385

(57) ABSTRACT

The subject disclosure provides for harvesting energy and converting the harvested energy with high efficiency for multiple power rails to a system load. For example, harvested energy is converted to a regulated output for a first power rail when the harvested energy satisfies a maximum power point tracking (MPPT) threshold, where the MPPT threshold corresponds to a high conversion efficiency. When the harvested energy drops below the MPPT threshold, the regulated output can be driven with stored energy associated with a second power rail from a super capacitor charged with the harvested energy during a high efficiency phase. This helps maintain the high conversion efficiency at the regulated output. In the event that the super capacitor does not have sufficient stored energy, a backup battery may drive the regulated output associated with a third power rail while still maintaining the high conversion efficiency at the regulated output.

### FIELD OF THE DISCLOSURE

The present description relates generally to power converter systems, and more particularly, to an energy harvesting power system.

### BACKGROUND

Power transmission and distribution (T&D) systems have evolved into vast interconnected power delivery networks between power generating stations to different end user loads. To monitor branches of the distribution grid as much as possible, especially for the overhead power lines in urban and rural areas, to quickly locate/respond to any fault and bring back its operation to a steady state condition within the minimum time possible is of utmost importance in the field.

Fault circuit indicators (FCIs) are an increasingly important solution for meeting monitoring requirements due to their easy implementation, low cost, and low maintenance needs. FCIs contain energy harvesting power management, storage element and system load including processors, analog front end (AFE) circuits, and communication interface devices. Smart energy harvesting power management, along with ultralow power consumption, are particularly critical to the design.

### SUMMARY OF THE DISCLOSURE

The subject disclosure provides for harvesting energy and converting the harvested energy with high efficiency for multiple power rails to a system load. For example, harvested energy is converted to a regulated output associated with a first power rail when the harvested energy meets or exceeds a maximum power point tracking (MPPT) threshold, where the MPPT threshold indicates an amount of power that corresponds to a high efficiency. In the event that the harvested energy drops below the MPPT threshold, the regulated output can be driven with stored energy associated with a second power rail from a super capacitor that was charged with the harvested energy during a high efficiency phase (or when the MPPT threshold was satisfied). This helps maintain the high efficiency at the regulated output. In the event that the super capacitor does not have sufficient stored energy, a backup battery may drive the regulated output associated with a third power rail while still maintaining the high efficiency at the regulated output.

According to an embodiment of the present disclosure, an apparatus for energy harvesting includes a current transformer configured to sense alternating current (AC) energy on a power line and harvest the sensed AC energy from the power line. The energy harvest power apparatus includes a bridge rectifier configured to convert the AC energy into direct current (DC) energy. The energy harvest power apparatus includes a power management unit (PMU) configured to receive the DC energy as an input voltage, compare the input voltage to MPPT threshold, and drive a load with the input voltage when the input voltage satisfies the MPPT threshold. The energy harvest power apparatus includes an energy storage element configured to store the DC energy when the input voltage satisfies the MPPT threshold and drive the load with the stored DC energy when the input voltage does not satisfy the MPPT threshold.

According to an embodiment of the present disclosure, a method of harvesting energy includes sensing AC energy on a power line. The method includes extracting the sensed AC energy from the power line. The method includes converting the extracted AC energy into DC energy. The method includes supplying the DC energy as an input voltage to a PMU. The method includes comparing the input voltage to a MPPT threshold. The method includes driving a load with the input voltage when the input voltage satisfies the MPPT threshold. The method includes driving the load with stored DC energy when the input voltage does not satisfy the MPPT threshold.

According to an embodiment of the present disclosure, a system for energy harvesting includes means for sensing AC energy on a power line. The system includes means for extracting the sensed AC energy from the power line. The system includes means for converting the extracted AC energy into DC energy. The system includes means for supplying the DC energy as an input voltage to a PMU. The system includes means for comparing the input voltage to a MPPT threshold. The system includes means for driving a load with the input voltage when the input voltage satisfies the MPPT threshold. The system includes means for driving the load with stored DC energy when the input voltage does not satisfy the MDPT threshold.

### BRIEF DESCRIPTION OF THE DRAWINGS

Certain features of the subject technology are set forth in the appended claims. However, for purposes of explanation, several embodiments of the subject technology are set forth in the following figures.

FIG. 1 conceptually illustrates an example of a power transmission system in accordance with one or more implementations of the subject technology.

FIG. 2 conceptually illustrates an example of a fault circuit indicator device and a high-level system diagram of the fault circuit indicator device in accordance with one or more implementations of the subject technology.

FIG. 3 illustrates a schematic diagram of an example energy harvest power system in accordance with one or more implementations of the subject technology.

FIG. 4 illustrates a plot diagram depicting an example rectifier power output curve with maximum power point tracking in accordance with one or more implementations of the subject technology.

FIG. 5A conceptually illustrates an operational waveform of an example energy harvest power system in accordance with one or more implementations of the subject technology.

FIG. 5B illustrates a plot diagram depicting an example efficiency curve relative to a maximum power point tracking curve in accordance with one or more implementations of the subject technology.

FIG. 6 illustrates a flowchart of an example process for energy harvesting in accordance with one or more implementations of the subject technology.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, the subject technology is not limited to the specific details set forth herein and may be practiced using one or more implementations. In one or more instances, structures and components are shown in block diagram form in order to avoid obscuring the concepts of the subject technology.

A conventional fault circuit indicator (FCI) power system uses two stages of linear regulators (e.g., LDO1, LDO2) to step down an input voltage to power a system load and concurrently provide a charge energy to a storage element. However, the two-stage LDO configuration induces a high voltage droop, thus causing the efficiency to drop to around 40%. The conventional FCI power system also includes a power supply transition with diodes, which degrades the efficiency and life of a backup battery, and is not configured to track efficiency of harvested energy.

The subject disclosure provides for a novel energy harvesting power system in fault circuit indicator devices that extracts energy efficiently from a power line with a current transformer (CT) and bridge rectifier and stores the extracted energy into a storage element with maximum power point tracking (MPPT) control. The subject energy harvesting power system not only charges a storage element but can also provide a regulated output to a system load with high efficiency that would be above 90% under 1 mA CT current. The subject energy harvesting power system can also operate at very low CT current because the input voltage can be in a range of 100 mV to 3.3 V and a typical minimum input power can be about 6 μW, for example. In all phases of operation, the subject energy harvesting power system harvests the energy and provides regulated voltages with high efficiency. For example, the subject energy harvesting power system drives a regulated output with a boost regulator when the input voltage meets or exceeds a MPPT threshold and the input energy exceeds the load consumption, thus utilizing the boost regulator at high efficiency. In this respect, the storage element is also charged with the input voltage during a high efficiency phase. The subject energy harvesting power system is configured with a super capacitor to drive a regulated output to maintain the high efficiency of the regulated output when the input voltage does not meet the MPPT threshold (e.g., in response to the input voltage meeting or exceeding the MPPT threshold). This is because the efficiency of the energy extracted from the harvester (e.g., CT) has been found to decrease when the input voltage falls below the MPPT threshold. The subject energy harvesting power system further provides the regulated output with a backup battery in order to maintain the high efficiency of the regulated output when the super capacity does not have sufficient stored energy to supply the system load.

In some implementations, an apparatus for energy harvesting includes a current transformer configured to sense AC energy on a power line and harvest the sensed AC energy from the power line. The energy harvest power apparatus includes a bridge rectifier configured to convert the AC energy into DC energy. The energy harvest power apparatus includes a power management unit (PMU) configured to receive the DC energy as an input voltage, compare the input voltage to a MPPT threshold, and drive a load with the input voltage when the input voltage satisfies the MPPT threshold. The energy harvest power apparatus includes an energy storage element configured to store the DC energy when the input voltage satisfies the MPPT threshold and drive the load with the stored DC energy when the input voltage does not satisfy the MPPT threshold.

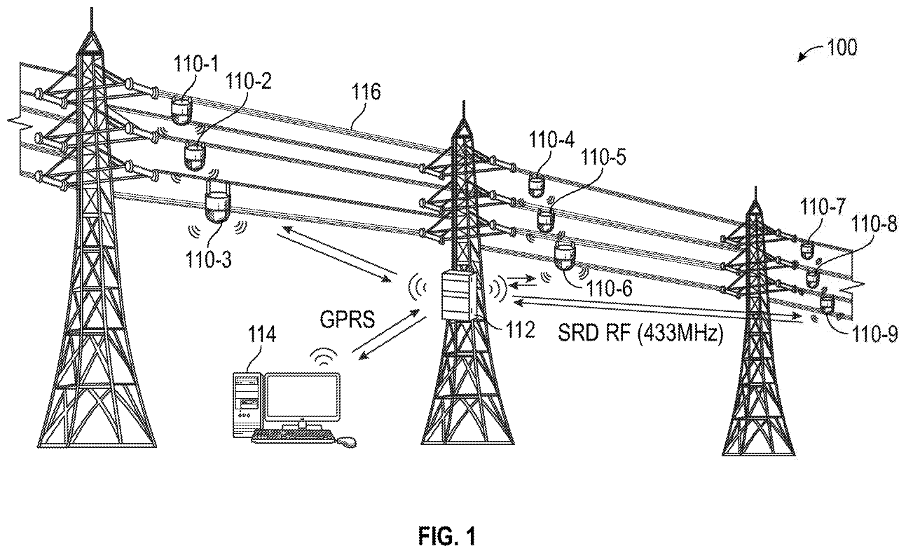

FIG. 1 conceptually illustrates an example of a power transmission system 100 in accordance with one or more implementations of the subject technology. Not all of the depicted components may be used, however, and one or more implementations may include additional components not shown in the figure. Variations in the arrangement and type of the components may be made without departing from the spirit or scope of the claims as set forth herein. Additional components, different components, or fewer components may be provided.

The power transmission system 100 includes acquisition units such as fault circuit indicators (FCIs) 110-1, 110-2, 110-3, 110-4, 110-5, 110-6, 110-7, 110-8 and 110-9, or collectively referred to as “FCIs 110.” The power transmission system 100 also includes a collection unit 112. In some implementations, the collection unit 112 communicates with the FCIs 110 individually over a first wireless network. In some aspects, the collection unit 112 communicates wirelessly with a client device 114 over a second wireless network. The first wireless network and the second wireless network can include, for example, any one or more of a cellular network, a personal area network, a local area network (LAN), a wide area network (WAN), the Internet, and the like. For example, the collection unit 112 communicates with the FCIs 110 over a short-range device (SRD) radio frequency network that operates in a frequency of about 433 MHz, however, the frequency range may vary without departing from the scope of the disclosure. For example, the collection unit 112 communicates with the client device 114 over a general packet radio service (GPRS) network. The power transmission system 100 includes transmission lines 116 that carry a high voltage that may receive universal AC-DC voltage conversion adjustment.

The power transmission system 100 provides power distribution between a power station and an end-user load. The power transmission system 100 may be an interconnected power transmission network, with multiple branches that may be difficult to monitor over long distances. The power transmission system 100 may experience a single-point failure that affects the entire power distribution.

In some aspects, weak energy harvesting (e.g., uW/mW level) provides system power, but requires efficient energy conversion. In some aspects, the power transmission system 100 includes considerations of impedance matching and output power supply optimization to prevent secondary waste of collected energy. The power transmission system 100 may need additional energy storage or alternative energy for the power transmission system 100. In some aspects, the power transmission system 100 includes a battery-replacement system, which has a short battery cycle and is generally difficult to maintain. In other aspects, the power-off installation method for the power transmission system 100 is not feasible, and the overhead risk factor is significantly high.

The FCIs 110 may provide monitoring rated for voltages in a range of 3 kV to 35 kV. In some aspects, the FCIs 110 provide monitoring rated at a frequency of about 50 Hz. The FCIs 110 may be installed on the distribution line (e.g., 116) to monitor the operating parameters of the line. For example, the FCIs 110 can monitor the three-phase load current of the line, the strength of the electric field, fault current, temperature, etc. The detection may be short since the FCIs 110 may be spaced apart at short distance intervals. The FCIs 110 are CT powered with a built-in supercapacitor and backup battery.

In some aspects, the FCIs 110 identify and indicate short-circuit and ground faults, acquisition line current, temperature, etc. For example, the FCIs 110 may accurately identify short-circuit faults and ground faults on the load side of the line, indicate the fault status in place, and provide fault information.

The FCIs 110 are configured to send monitoring information and fault detection data to the collection unit 112, which then forwards the data to a remote master station. For example, the FCIs 110 upload fault information, line current, line temperature, and other information to the collection unit 112. In some aspects, the FCIs 110 may send the data to the master station in real time. In other aspects, the FCIs 110 record the three-phase load current and electric field intensity before and after a fault is detected and send the recorded data to the remote master station at a scheduled time. In some aspects, the FCIs 110 may send other operating information, as well as main power supply, backup power and other status information to the collection unit 112. In some aspects, the collection unit 112 may query or ping the FCIs for available monitoring information, and receive the information via a download, when available.

The collection unit 112 is configured to receive and process the distribution line monitoring data uploaded by the acquisition unit (e.g., FCIs 110). The collection unit 112 may process information on barrier, current, temperature, and other monitoring information, as well as power distribution data. In some aspects, the collection unit can be powered by a current transformer (CT), solar energy, a power supply (e.g., AC 220V) or other power supply methods. In an aspect, the collection unit 112 includes a built-in backup power supply. The CT may be, for example, positioned around or placed proximate to a transmission line 116.

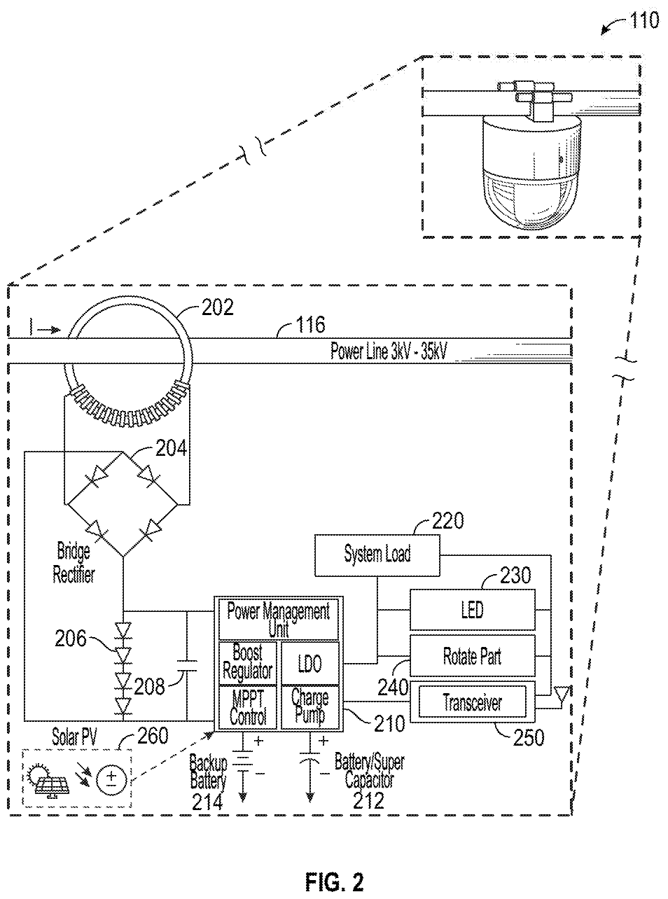

FIG. 2 conceptually illustrates an example of a fault circuit indicator device 110 and a high-level system diagram of the fault circuit indicator device 110 in accordance with one or more implementations of the subject technology. Not all of the depicted components may be used, however, and one or more implementations may include additional components not shown in the figure. Variations in the arrangement and type of the components may be made without departing from the spirit or scope of the claims as set forth herein. Additional components, different components, or fewer components may be provided.

In FIG. 2, the fault circuit indicator device includes a novel FCI energy harvesting power system. In some implementations, the fault circuit indicator device 110 is an integrated energy harvesting, ultralow power management unit (PMU) solution that converts dc power from the CT 202 or photovoltaic cells (e.g., 260).

As shown in FIG. 2, the fault circuit indicator device includes a current transformer 202, a bridge rectifier 204, a protection circuit 206, an input capacitor 208, a power management unit 210, an energy storage element 212, a backup energy storage element 214, a system load 220, a light emitting diode 230, a rotate part 240, and a transceiver 250. The subject system can extract energy efficiently from the power line 116 with the current transformer 202 and the bridge rectifier 204 to the energy storage element 212 for energy harvesting. The subject system can automatically manage multiple power supplies such as an inductive harvester, the energy storage element 212, the backup energy storage element 214, and the system load 220.

The CT 202 generates AC energy from the power line 116. The CT 202 may measure the AC current, and produces AC power in its secondary winding that is proportional to the measured AC current in its primary winding.

The bridge rectifier 204 is coupled to the secondary winding of the CT 202, and converts the AC power to DC power. The bridge rectifier 204 may include an arrangement of four diodes in a bridge circuit configuration.

The power management unit (PMU) 210 includes a maximum power point tracking (MPPT) control circuit, a low dropout linear regulator (LDO) circuit, a boost regulator circuit, and a charge pump circuit.

In some implementations, there are two modes of regulator operation: 1) boost mode, 2) LDO mode. In some aspects, the power management unit 210 can be set to a mixed mode. In the mixed mode, when the regulated output voltage (e.g., REG_OUT) meets or exceeds a set value, the power management unit 210 operates in boost mode, otherwise, the power management unit 210 switches to a LDO mode.

In some implementations, the MPPT control circuit keeps the input voltage ripple in a fixed range to maintain stable dc-to-dc boost conversion. The MPPT control circuit allows extraction of the highest possible energy from the harvester (e.g., CT 202). A programmable minimum operation threshold (e.g., MPPT threshold) enables boost shutdown during a low input condition. In this respect, the subject system extracts the energy from the CT 202 and stores the extracted energy into the energy storage element 212 based on the MPPT threshold.

The input voltage may range from 100 mV to 3.3 V, and thus, the PMU 210 can operate with a rectify voltage as low as 380 mV during low energy in the CT 202. In some aspect, the regulation output is in a range of 1.5V to 3.6V. In some implementations, the energy harvesting power system provides efficient conversion of the harvested limited power from a 6 μW to 600 mW range with sub-microwatt operation losses. With the internal cold start circuit (e.g., charge pump circuit), the boost regulator circuit can start operating at an input voltage as low as 380 mV. After a cold startup, the boost regulator is functional at an input voltage range of 0.08 V to 3.3 V. An additional 150 mA regulated output can be programmed by an external resistor divider (not shown).

The PMU 210 can extract the DC energy from the bridge rectifier 204 and charge the energy storage element 212, and can convert the extracted power to a regulated output with the boost regulator circuit. The PMU 210 can sustain the system load 220 (e.g., processor, monitoring analog front-end devices, RF) with the boost regulator circuit when the input power is sufficient to support the system load 220. The PMU 210 can convert the power stored by the energy storage element 212 to sustain the system load when the boost regulator circuit is disabled.

The energy storage element 212 can store the extracted energy and keep the system alive when the input power is insufficient for the system load. The energy storage element 212 is capable of sustaining a high peak current from the system load 220 such as RF transmissions. In FIG. 2, the energy storage element 212 is a super capacitor, however, the energy storage element 212 may be a rechargeable Li-Ion battery, a thin film battery, a conventional capacitor, a power up small electronic device or a battery free system, without departing from the scope of the disclosure.

In some aspects, the backup energy storage element (e.g., 214) can be connected and managed by an integrated power path management control block that is programmable to switch the power source from the energy harvester (e.g., 202, 204), the rechargeable energy storage element (e.g., 212), and the backup energy storage element (e.g., 214). The backup energy storage element 214 is coupled to the PMU 210 to sustain the system load 220 when power at the input side and the energy storage element 212 are not sufficient to keep the system load 220 alive. The transition threshold for transitioning to the backup energy storage element 214 can be programmed to extend the battery life.

In various implementations, the protection circuit 206 is configured to protect the over voltage and surge current during a high current in the power line 116. In this regard, the protection circuit 206 may be coupled to terminals across the bridge rectifier 204. The protection circuit 206 may be made up of a series of diodes. For example, the protection circuit 206 can include two to three low-leakage diodes to limit the open-circuit input voltage of the power management unit 210 to around 2.1V to control the open-circuit input voltage. At the same time, the MPPT control circuit can determine whether the CT works near the maximum power point (e.g., satisfies the MPPT threshold). In some implementations, a comparator (not shown) in series with a switch (not shown) are connected between the bridge rectifier 204 and the protection circuit 206. The comparator may be configured to compare the input voltage (e.g., V_{IN}) to a predetermined overvoltage threshold. The output of the comparator drives the gate of the switch to control the current flow between the bridge rectifier 204 and the protection circuit 206. For example, when the input voltage does not exceed the predetermined overvoltage threshold, then the comparator causes the switch to pass the input current to the PMU 210, and use the protection circuit 206 for short term or surge current protection purposes. The comparator may also cause the switch to shunt the input current from the protection circuit 206 when the input voltage is determined to exceed the predetermined overvoltage threshold and present for a long term, to avoid excessive heating of the protection circuit 206 and thereby protect the protection circuit 206 from heat damage. The predetermined overvoltage threshold may correspond to the maximum input voltage to the PMU 210.

The input capacitor 208 may be set to a relative small capacitance value (e.g., in a range of 4.7 μF to 47 μF), otherwise the input capacitance 208 may affect the MPPT periodic detection accuracy.

In some implementations, the fault circuit indicator device 110 is implemented on a single chip (or single semiconductor die) for energy harvesting and energy management. In other implementations, the fault circuit indicator device may be implemented on multiple chips (or multiple semiconductor die) without departing from the scope of the disclosure.

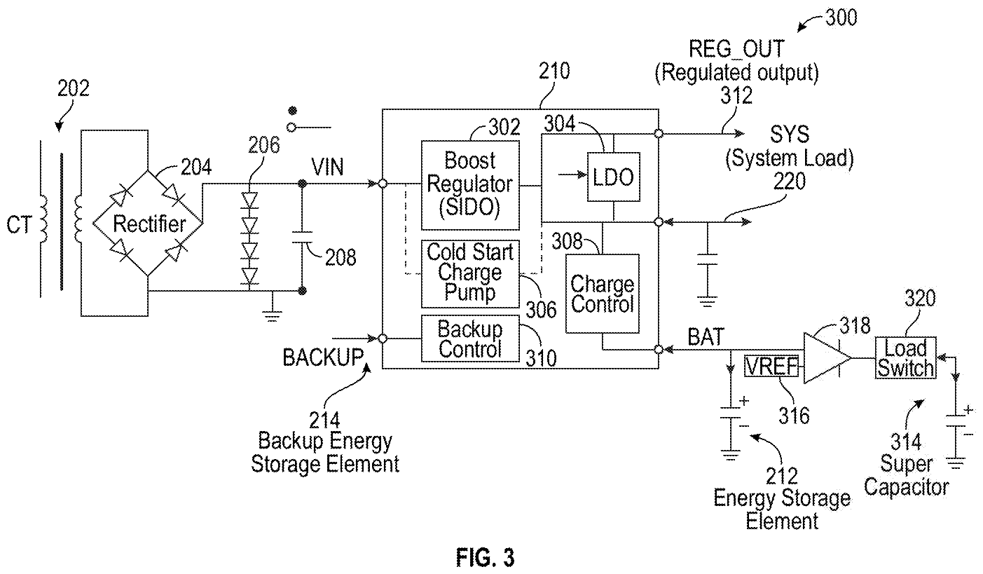

FIG. 3 illustrates a schematic diagram of an example energy harvest power system 300 in accordance with one or more implementations of the subject technology. Not all of the depicted components may be used, however, and one or more implementations may include additional components not shown in the figure. Variations in the arrangement and type of the components may be made without departing from the spirit or scope of the claims as set forth herein. Additional components, different components, or fewer components may be provided.

In FIG. 3, the power management unit (PMU) 210 includes a boost regulator circuit 302, a low dropout linear regulator (LDO) circuit 304, a cold start charge pump circuit 306, a charge control circuit 308, and a backup control circuit 310. In some aspects, the charge control circuit 308 may be, or a part of, a maximum power point tracking (MPPT) control circuit.

The energy harvest power system 300 includes a current transformer (e.g., 202) configured to sense AC energy on a power line (e.g., 116) and harvest the sensed AC energy from the power line. The energy harvest power apparatus 300 includes a bridge rectifier (e.g., 204) configured to convert the AC energy into DC energy. The bridge rectifier 204 may be configured to utilize a 0.3V tube voltage drop, thereby providing a low leakage current pipe structure. As a result, the power consumed on the bridge rectifier 204 itself is low.

The energy harvest power apparatus 300 also includes a PMU (e.g., 210) configured to receive the DC energy as an input voltage, compare the input voltage to a MPPT threshold, and drive a load (e.g., 220) with the input voltage when the input voltage satisfies the MPPT threshold. The energy harvest power apparatus 300 includes an energy storage element (e.g., 212) configured to store the DC energy when the input voltage satisfies the MPPT threshold and drive the load with the stored DC energy when the input voltage does not satisfy the MPPT threshold.

In some implementations, the energy harvesting power system includes three power inputs (e.g., input voltage (e.g., VIN), energy storage element (e.g., BAT), backup energy storage element (e.g., BACKUP). In some aspects, the input voltage VIN is the main power input and can supply an input voltage in a range of 80 mV to 3.3V. When activated, the input voltage can supply a cold start voltage as low as 380 mV. The power management unit 210 has two power outputs: 1) a system power output, and 2) a regulated output. The system power output drives an output voltage that is equivalent to the super capacitor (e.g., 314) or rechargeable battery voltage (e.g., 212) used to power the chip (or integrated circuit die). The regulated output may serve as a load power supply. In some aspects, the regulated output may be equivalent to the output of the system power supply.

The boost regulator circuit 302 is configured to receive the input voltage and produce a first regulated voltage. The boost regulator circuit 302 may be a switching mode synchronous boost regulator that operates in pulse frequency modulation (PFM) mode and transfers energy stored in the input capacitor 208 to the energy storage element 212. The LDO circuit 304 is configured to receive a stored voltage from the energy storage element 212 and produce a second regulated voltage.

In some aspects, the MPPT control circuit (e.g., 308) is configured to measure an open circuit voltage of the input voltage at an input to the PMU 210 and produce the MPPT threshold. The MPPT control circuit can regulate the input voltage (e.g., VIN) at a level sampled at an input to the MPPT control circuit and stored at the input capacitor 208. To maintain the high conversion efficiency of the boost regulator circuit 302 across a wide input power range, the current sense circuitry employs an internal dither peak current limit to control the inductor current. In some aspects, the MPPT threshold indicates a range of maximum power produced by the bridge rectifier 204 that corresponds to a high conversion efficiency of the boost regulator circuit 302.

In some aspects, the PMU 210 is configured to cause the boost regulator circuit 302 to drive an output of the PMU 210 with the first regulated voltage when the input voltage satisfies the MPPT threshold.

In some aspects, the PMU 210 is configured to cause the LDO circuit 304 to drive the output of the PMU 210 when the input voltage does not satisfy the MPPT threshold. In an aspect, the boost regulator circuit 210 is disabled when the input voltage does not satisfy the MPPT threshold. For example, when the main power is lost (e.g., the input voltage falls below the MPPT threshold), the system load 220 is supplied with a voltage by the energy storage element 212. In some aspects, the power is supplied by the energy storage element 212 until the voltage on the energy storage element 212 drops to a certain level. In an aspect, the certain level may be set to a minimum of 2V, but the value may be arbitrary depending on implementation without departing from the scope of the disclosure. In some implementations, the energy storage element port (e.g., BAT) is a chargeable system power input. In some implementations, the energy storage element port is connected to a super capacitor, or is connected to a rechargeable battery in other implementations.

In some aspects, the PMU 210 is configured to measure an output of the PMU 210 to determine a regulated output voltage (e.g., REG_OUT) and determine whether the regulated output voltage exceeds a maximum boost threshold. The maximum boost threshold may indicate a level at which the current is significantly high and can cause damage to the system load 220. In some aspects, the PMU 210 is configured to enable the boost regulator circuit 302 to drive the output of the PMU 210 when the regulator output voltage does not exceed the maximum boost threshold. In some aspects, the PMU 210 is configured to disable the boost regulator circuit 302 from driving the output of the PMU 210 when the regulator output voltage exceeds the maximum boost threshold. In an aspect, the boost regulator circuit 302 is disabled until the regulator output voltage is reduced to less than the maximum boost threshold. For example, the boost regulator circuit 302 may be restarted to drive the load when the regulated output voltage decreases to a level that is acceptable and safe to the system load 220.

In some aspects, the PMU 210 is configured to enable the boost regulator circuit 302 to drive the output of the PMU with the first regulated voltage when the regulator output voltage does not exceed the maximum boost threshold and exceeds a boost enable threshold that is less than the maximum boost threshold. The boost enable threshold may indicate a voltage at which is needed to operate the boost regulator circuit 302 with the highest conversion efficiency. In some aspects, the PMU 210 is configured to keep enabling the boost regulator circuit 302 from driving the output of the PMU 210 when the regulator output voltage does not exceed the boost enable threshold.

In some aspects, the PMU 210 is configured to enable the LDO circuit 304 to drive the output of the PMU 210 with the second regulated voltage when the regulator output voltage does not exceed an LDO enable threshold that is less than the boost enable threshold. In some aspects, the PMU 210 is configured to disable the LDO circuit 304 from driving the output of the PMU 210 when the regulator output voltage exceeds the LDO enable threshold. In some aspects, the LDO enable threshold indicates a voltage at which the LDO circuit 304 can operate with a high conversion efficiency.

In some implementations, the backup energy storage element 214 is coupled to the PMU 210 and is configured to drive the load (e.g., 220) when the input voltage does not satisfy the MPPT threshold. For example, the backup energy storage element 214 is enabled when the main power of the system is not supplied. In some aspects, the voltage on the energy storage element 212 is also not sufficient to supply to the system load 220. In this respect, the backup energy storage element 214 supplies power to the system load 220 via the LDO circuit 304. In some aspects, the backup energy storage element 214 is output in one direction and cannot be charged.

In some aspects, when the LDO circuit 304 is enabled to drive the output of the PMU 210, the PMU 210 is configured to measure a first stored energy of the energy storage element 212 and a second stored energy of the backup energy storage element 214 and determine whether the first stored energy of the energy storage element 212 exceeds the second stored energy of the backup energy storage element 214. In some aspects, the PMU 210 is configured to enable the energy storage element 212 to drive the LDO circuit 304 with the first stored energy when the first stored energy exceeds the second stored energy. In some aspects, the PMU 210 is configured to enable the backup energy storage element 214 to drive the LDO circuit 304 with the second stored energy when the first stored energy does not exceed the second stored energy.

In some aspects, the MPPT control circuit comprises a voltage divider circuit between an output of the bridge rectifier 204 and an input to the PMU 210. In some aspects, the voltage divider circuit is configured to determine a voltage ratio of the input voltage and determine a rectifier current output from the voltage ratio. In other aspects, the PMU 210 is configured to determine a rectifier power output with the rectifier current output. In this respect, the MPPT threshold corresponds to a maximum value of the rectifier power output.

In some implementations, the charge control function (e.g., 308) of the power management unit 210 is configured to protect the rechargeable energy storage, which is achieved by monitoring the battery voltage of the energy storage element 112 with a programmable charging termination voltage and a shutdown discharging voltage.

In some implementations, the cold start charge pump circuit 306 extracts energy available at the input voltage port (e.g., VIN) and charges only the capacitors at the system power output port (e.g., SYS) to a predetermined system threshold (e.g., VSYS_TH) at which the boost regulator circuit 302 and the charge control circuit 308 begin operating. The boost regulator circuit 302 charges the energy storage element 112 when the voltage of the system power output (e.g., SYS) is greater than a predetermined charging threshold (e.g., VSYS_CHG). When the voltage of the system power output is less than the predetermined charging threshold with a hysteresis, the boost regulator circuit 302 stops charging the energy storage element 112 and restarts charging the system power output to ensure that it does not enter a cold startup.

In some implementations, the energy harvest power system 300 includes a super capacitor 314 that is separate from the energy storage element 212. In some aspect, the super capacitor 314 has a capacitance in a range of 10 F to 100 F. In FIG. 3, the super capacitor 314 has a capacitance of 10 F. In some aspects, the capacitance of the energy storage element 212 is in a range of 1000 μF to 3300 μF.

The energy harvest power system 300 has two stages in charging the rechargeable batteries (e.g., the energy storage element 212 and the super capacitor 314). According to the system load 220, the first stage capacitance is charged as quickly as possible to support the load power-up peak power consumption. In some aspects, according to the minimum operating voltage of the system load 220, a comparator 318 is selected to charge the super capacitor 314 to a certain voltage range (e.g., a reference voltage 316). The energy harvest power system 300 includes a load switch 320 as a second stage capacitance charging switch. The load switch 320 has advantages over traditional transistor switches (e.g., metal-oxide semiconductor field-effect transistors (MOSFETs)) such as having a smaller leakage current and the circuit design is more concise and reliable. In operation, if the voltage on the energy storage element port (e.g., BAT) exceeds the reference voltage 316, then the super capacitor 314 is charged through the load switch 320. Otherwise, the super capacitor 314 is not charged. In some aspects, the super capacitor 314 is charged until the voltage on the energy storage element port (e.g., BAT) is decreased to a voltage level less than the reference voltage 316.

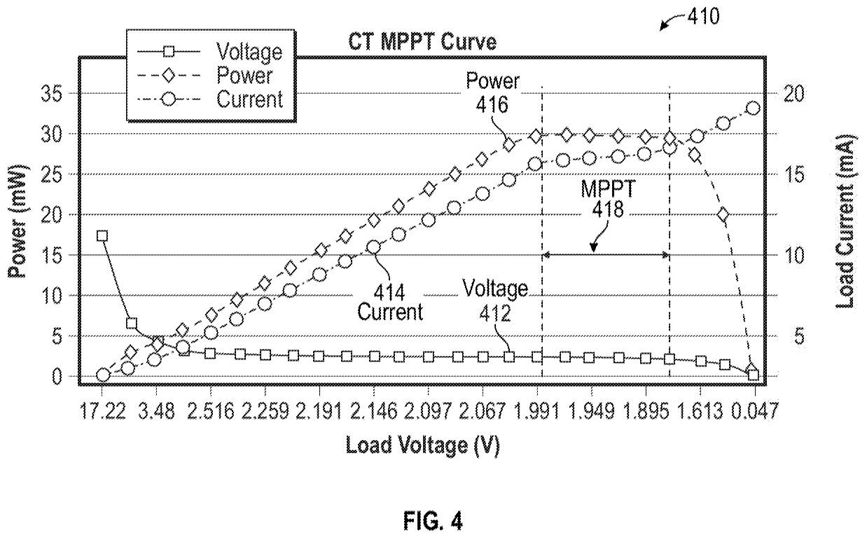

FIG. 4A illustrates a plot diagram 410 depicting an example rectifier power output curve with maximum power point tracking in accordance with one or more implementations of the subject technology. The plot diagram 410 depicts three curves: 1) a DC voltage curve 412 of the rectifier output, 2) a rectifier current output curve 414, and 3) a rectifier power output curve 416. As shown in FIG. 4A, the load voltage (illustrated by the curve 412) can be measured initially at about 17 VDC as an open circuit voltage with no load and reduce to about 50 mVDC with heavy load. At the same time, the load current (illustrated by the curve 414) can be measured initially at 0 mA (when the load voltage is measured at about 17 VDC) and increase to about 20 mA (when the load voltage is measured at about 50 mVDC). The power output (illustrated by the curve 416) can be measured initially at about 0 mW (when the load voltage is measured at about 17 VDC) and increase to a maximum value of about 30 mW (when the load voltage is measured between 2.0 VDC and 1.7 VDC). The MPPT control circuit can indicate a number of maximum power points (e.g., 418) along the rectifier power output curve 416. At these maximum power points, the PMU 210 can get the highest energy from current transformer 202 and bridge rectifier 204. As illustrated in FIG. 4A, the MPPT can be measured when the output power reaches 30 mW. By operating the boost regulator circuit 302 when the input voltage corresponds to the maximum power points, the conversion efficiency of the power management unit 210 can be held high.

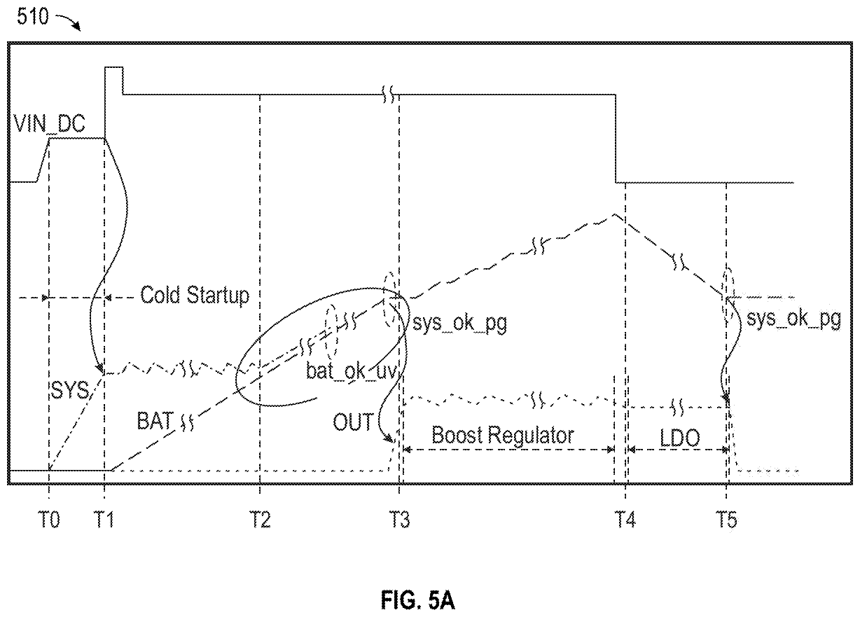

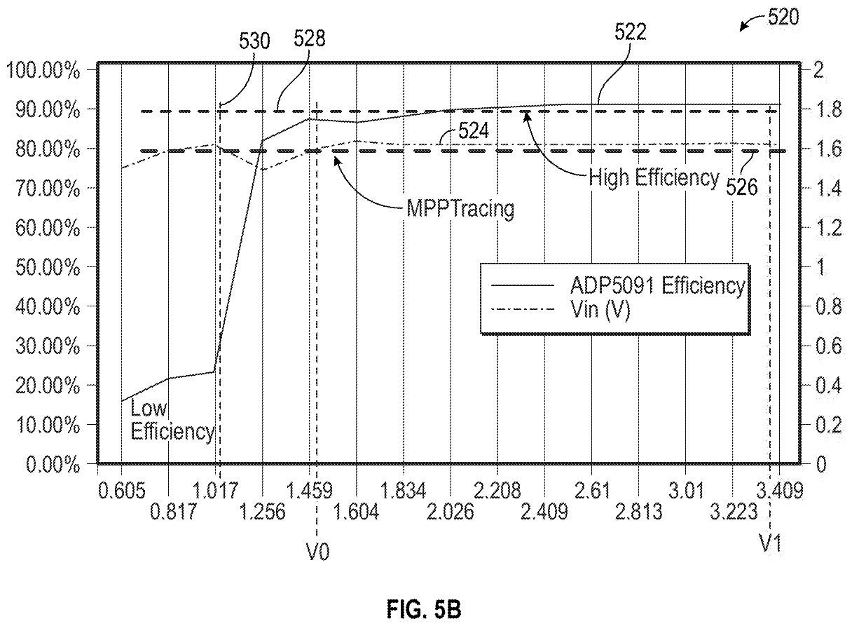

FIG. 5A conceptually illustrates an operational waveform 510 of an example energy harvest power system in accordance with one or more implementations of the subject technology.

In some implementations, there may be no battery backup (e.g., backup energy storage element 114) available to the power management unit 210 in an initial state of the power management unit 210. In this respect, a cold startup sequence is performed on the power management unit 210. In the initial cold start phase, both the voltage of the system power output (e.g., SYS) and the voltage of the energy storage element 112 are set to 0V (e.g., time T0). The input to the power management unit 210 is also turned off.

After the current transformer 202 has driven an output with extracted AC energy to the bridge rectifier 204, the DC current is charged into the input capacitor 208 through the bridge rectifier 204. As the input of the power management unit 210 is initially turned off, the voltage in the input capacitor 208 gradually increases to 380 mV. After the input capacitor 208 reaches 380 mV, the input of the power management unit 210 is turned on and the cold-start charge pump circuit 306 begins operating. The output current of the cold start charge pump circuit 306 is output to the system output port (e.g., SYS), and the voltage at the system output port increases. At the same time, the charge control 308 does not allow charging to the energy storage element 112. When the system power output voltage increases to 1.8V, the energy storage element 112 is not yet charged. At this time, there is no output driven on the regulated output port (e.g., REG_OUT).

In other implementations, the power management unit 210 skips a cold startup phase when the backup energy storage element 214 is coupled to the power management unit 210 and is full of stored energy. In an initial state, the system power output is driven high and a voltage of the energy storage element 112 remains unchanged (e.g., held low). After the current transformer 202 has driven an output, the extract energy can be converted and charged to the energy storage element 112. In some implementations, the energy storage element 112 is charged until the voltage on the input node to the energy storage element 112 exceeds the voltage at an output node of the backup energy storage element 114.

While the system power output voltage is being increased to 1.8V, the energy conversion efficiency of the power management unit 210 is significantly low (<10%). In this respect, the LDO circuit 304 is turned off during this process to ensure that the system power output voltage increases quickly to the target voltage. When the system power output voltage reaches 2.1V, the power management unit transitions from a low efficiency phase (or first stage) into a medium efficiency phase (or second stage) non-synchronous boost mode.

When the voltage on the system power output port exceeds 2.1V, the energy storage element 112 begins to be charged (e.g., time T1). The conversion efficiency of the power management unit 210 in the second stage is improved compared to the first stage. For example, the conversion efficiency during the second stage is approximately 30 to 50%. Between times T1 and T2, the voltage of energy storage element 112 gradually increases and the voltage of the system power output remains between 1.8V and 2.1V due to no additional energy. The voltage of the system power output will remain in a hysteresis condition until the energy storage element 112 is charged to a battery threshold (e.g., VBAT_SD). Once the voltage of the energy storage element 112 exceeds the battery threshold, the voltages of the system power output and the energy storage element 112 increase in unison, and the chip conversion efficiency will enter a high efficiency phase synchronous boost mode.

After the second phase, the voltage of the system power output (at the same time as the voltage of the energy storage element 112) continues to increase until the voltage of the system power output exceeds a predetermined system power threshold (or at time T3).

In some aspects, the voltage level of the system power output may be at about 3.3V when the predetermined system power threshold is satisfied. In turn, the system load 220 can begin to receive power and begin operating. Between times T3 and T4, the boost regulator circuit is enabled and outputting a regulated voltage to the regulated output so long as the input voltage meets or exceeds the MPPT threshold. At time T4, the input voltage falls below the MPPT threshold and the boost regulator circuit 302 is then disabled. In turn, the LDO circuit 304 is enabled to drive the load with a second regulated voltage based on the stored DC energy from the energy storage element 212. Between times T4 and T5, the LDO circuit 304 drives the load using the energy storage element 212. At time T5, the energy stored in the energy storage element 212 is depleted to a certain level and therefore the LDO circuit 304 is disabled.

FIG. 5B illustrates a plot diagram 520 depicting an example storage element charging efficiency relative to the storage element voltage and MPPT effect in accordance with one or more implementations of the subject technology. The plot diagram 520 depicts two curves: 1) a conversion efficiency curve 522 of the power management unit 210, and 2) an input voltage curve 524. The MPPT tracing indicates at which input voltage corresponds to a high efficiency phase of the power management unit 210. As discussed in FIG. 5A, for operating the boost regulator circuit 302, when the input voltage is in a range where the maximum power points are present, then the highest extracted energy can be obtained from the current transformer 202 and bridge rectifier 204. In order to save storage element charging time, the boost regulator circuit 302 has to operate in a synchronous boost mode to achieve the highest conversion efficiency by driving a battery threshold (e.g., VBAT_SD) high. When the energy storage element (e.g., 212) voltage exceeds a switch turn-on level (e.g., at the line 530), the boost regulator circuit 302 can gradually operate in the synchronous boost mode and the conversion efficiency increases rapidly (e.g., with a steep positive slope). The input voltage curve 524 may be proximate to a MPPT curve 426 for the entire storage element charging process.

In FIG. 5B, the input voltage prior to V0 is below the MPPT curve 526, and thus would cause the boost regulator circuit 302 to operate in a low efficiency level (e.g., less than voltage value corresponding to line 530). Operating the boost regulator circuit 302 when the input voltage curve 524 falls below the MPPT curve 526 is not desirable. In some aspects, the MPPT threshold corresponds to the maximum power point values. After V0, the input voltage curve 524 meets or exceeds the MPPT curve 526, and thus would cause the boost regulator circuit 302 to operate at or near a high efficiency level (e.g., 528). In this respect, the boost regulator circuit 302 may be enabled to drive the load while the input voltage curve meets or exceeds the MPPT threshold 524 between V0 and V1.

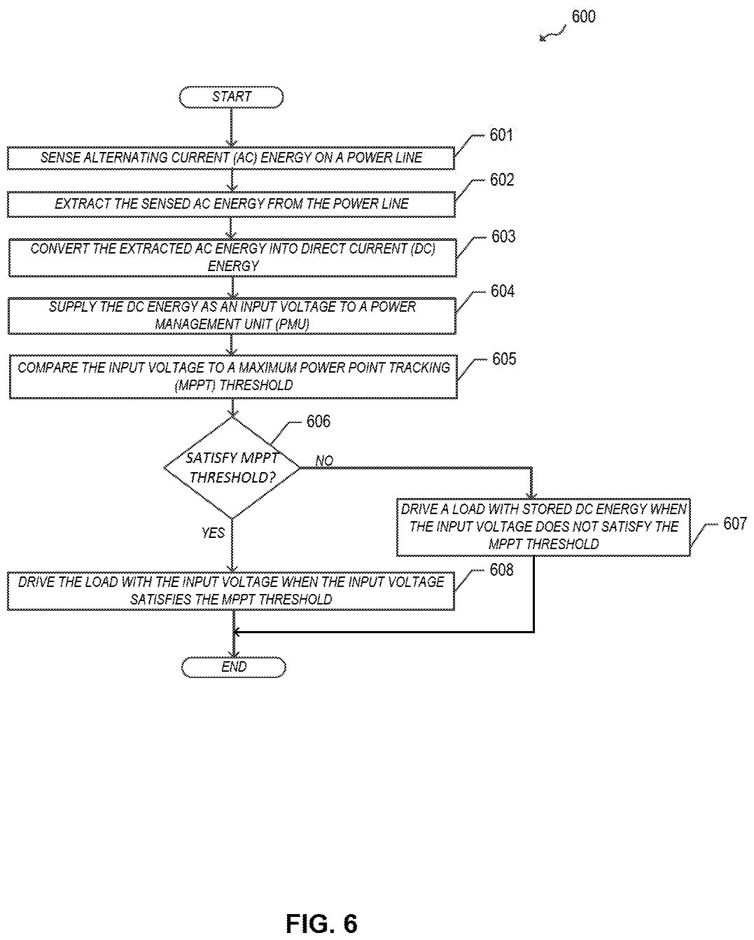

FIG. 6 illustrates a flowchart of an example process 600 for energy harvesting in accordance with one or more implementations of the subject technology. Further for explanatory purposes, the blocks of the sequential process 600 are described herein as occurring in serial, or linearly. However, multiple blocks of the process 600 may occur in parallel. In addition, the blocks of the process 600 need not be performed in the order shown and/or one or more of the blocks of the process 600 need not be performed.

The process 600 starts at step 601, where an alternating current (AC) energy is sensed on a power line. Next, at step 602, the sensed AC energy is extracted from the power line. Subsequently, at step 603, the extracted AC energy is converted into direct current (DC) energy. Next, at step 604, the DC energy is supplied as an input voltage to a power management unit (PMU). Subsequently, at step 605, the input voltage is compared to a maximum power point tracking (MPPT) threshold. At step 606, if the input voltage is determined to satisfy the MPPT threshold, then the process 600 proceeds to step 608. Otherwise, the process 600 proceeds to step 607. Next, at step 608, a system load is driven with the input voltage when the input voltage was determined to satisfy the MPPT threshold. Otherwise, at step 607, the system load is driven with stored DC energy from either a storage element such as a super capacitor or a backup battery when the input voltage does not satisfy the MPPT threshold.

In driving the load with the input voltage, the process 600 includes a step for driving an output of the PMU with a first voltage signal from a boost regulator circuit of the PMU when the input voltage satisfies the MPPT threshold (e.g., in response to the input voltage meeting or exceeding the MPPT threshold).

In driving the load with the stored DC energy, the process 600 includes a step for driving the output of the PMU with a second voltage signal from a low dropout linear regulator (LDO) circuit when the input voltage does not satisfy the MPPT threshold (e.g., in response to the input voltage being lower than the MPPT threshold).

The process 600 includes a step for measuring an output of the PMU to determine a regulated output voltage and determining whether the regulated output voltage exceeds a first threshold. The process 600 includes a step for enabling a boost regulator circuit of the PMU to drive the output of the PMU when the regulator output voltage does not exceed the first threshold. The process 600 includes a step for disabling the boost regulator circuit from driving the output of the PMU when the regulator output voltage exceeds the first threshold. In some aspects, the boost regulator circuit is disabled until the regulator output voltage is reduced to less than the first threshold.

The process 600 includes a step for driving the output of the PMU with the boost regulator circuit when the regulator output voltage does not exceed the first threshold and exceeds a second threshold less than the first threshold. The process 600 includes a step for driving the output of the PMU with a low dropout linear regulator (LDO) circuit when the regulator output voltage does not exceed a third threshold less than the second threshold.

The process 600 includes a step for charging the LDO circuit with a first stored energy of an energy storage element when the first stored energy exceeds a second stored energy of a backup energy storage element. The process 600 includes a step for charging the LDO circuit with the second stored energy when the first stored energy does not exceed the second stored energy.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

The predicate words “configured to”, “operable to”, and “programmed to” do not imply any particular tangible or intangible modification of a subject, but, rather, are intended to be used interchangeably. For example, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

The phrases “in communication with” and “coupled” mean in direct communication with or in indirect communication with via one or more components named or unnamed herein (e.g., a memory card reader).

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “example” or “exemplary” is used herein to mean “serving as an example or illustration.” Any aspect or design described herein as “example” or “exemplary” is not necessarily to be construed as preferred or advantageous over other aspects or designs.

As used herein, the singular forms “a”, “an” and “the” are intended to include the plural forms as well, unless the context clearly indicates otherwise. Numeric terms such as “first”, “second”, “third,” etc., unless specifically stated, are not used herein to imply a particular ordering of the recited structures, components, capabilities, modes, steps, operations, or combinations thereof with which they are used. Unless otherwise described herein, the phrase “meet”, “meeting”, “satisfy”, or “satisfying” a threshold may be interpreted to mean being equal with the threshold, being below the threshold, or being above the threshold, so long as the condition to be satisfied is predetermined prior to the threshold being satisfied.

The terms “comprise,” “comprising,” “includes,” and “including”, as used herein, specify the presence of one or more recited structures, components, capabilities, modes, steps, operations, or combinations thereof, but do not preclude the presence or addition of one or more other structures, components, capabilities, modes, steps, operations, or combinations thereof.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.” Furthermore, to the extent that the term “include,” “have,” or the like is used in the description or the claims, such term is intended to be inclusive in a manner similar to the term “comprise” as “comprise” is interpreted when employed as a transitional word in a claim.

What is claimed is:

1. An apparatus for energy harvesting, comprising:
a current transformer configured to sense alternating current (AC) energy on a power line and harvest the sensed AC energy from the power line;
a bridge rectifier configured to convert the AC energy into direct current (DC) energy;
a power management unit (PMU) configured to:
receive the DC energy as an input voltage;
compare the input voltage to a maximum power point tracking (MPPT) threshold; and
drive a load with the input voltage when the input voltage satisfies the MPPT threshold; and
an energy storage element configured to:
store the DC energy when the input voltage satisfies the MPPT threshold; and
drive the load with the stored DC energy when the input voltage does not satisfy the MPPT threshold.

2. The apparatus of claim 1, wherein the PMU comprises a MPPT control circuit configured to measure an open circuit voltage of the input voltage at an input to the PMU and produce the MPPT threshold, a boost regulator circuit configured to receive the input voltage and produce a first regulated voltage, and a low dropout linear regulator (LDO) circuit configured to receive a stored voltage from the energy storage element and produce a second regulated voltage.

3. The apparatus of claim 2, wherein the PMU is configured to:
cause the boost regulator circuit to drive an output of the PMU with the first regulated voltage when the input voltage satisfies the MPPT threshold; and
cause the LDO circuit to drive the output of the PMU with the second regulated voltage when the input voltage does not satisfy the MPPT threshold, wherein the boost regulator circuit is disabled when the input voltage does not satisfy the MPPT threshold.

4. The apparatus of claim 3, wherein the MPPT threshold indicates a range of maximum power produced by the bridge rectifier that corresponds to a high efficiency of the boost regulator circuit.

5. The apparatus of claim 2, wherein the PMU is configured to:
measure an output of the PMU to determine a regulated output voltage;
determine whether the regulated output voltage exceeds a maximum boost threshold;
enable the boost regulator circuit to drive the output of the PMU when the regulator output voltage does not exceed the maximum boost threshold; and
disable the boost regulator circuit from driving the output of the PMU when the regulator output voltage exceeds the maximum boost threshold, wherein the boost regulator circuit is disabled until the regulator output voltage is reduced to less than the maximum boost threshold.

6. The apparatus of claim 5, wherein the PMU is configured to:
enable the boost regulator circuit to drive the output of the PMU with the first regulated voltage when the regulator output voltage does not exceed the maximum boost threshold and exceeds a boost enable threshold less than the maximum boost threshold; and
disable the boost regulator circuit from driving the output of the PMU when the regulator output voltage does not exceed the boost enable threshold.

7. The apparatus of claim 6, wherein the PMU is configured to:
enable the LDO circuit to drive the output of the PMU with the second regulated voltage when the regulator output voltage does not exceed an LDO enable threshold less than the boost enable threshold; and
disable the LDO circuit from driving the output of the PMU when the regulator output voltage exceeds the LDO enable threshold.

8. The apparatus of claim 5, further comprising:
a backup energy storage element coupled to the PMU and configured to drive the load when the input voltage does not satisfy the MPPT threshold.

9. The apparatus of claim 8, wherein, when the LDO circuit is enabled to drive the output of the PMU, the PMU is configured to:
measure a first stored energy of the energy storage element and a second stored energy of the backup energy storage element;
determine whether the first stored energy of the energy storage element exceeds the second stored energy of the backup energy storage element;
enable the energy storage element to drive the LDO circuit with the first stored energy when the first stored energy exceeds the second stored energy; and
enable the backup energy storage element to drive the LDO circuit with the second stored energy when the first stored energy does not exceed the second stored energy.

10. The apparatus of claim 2, wherein the MPPT control circuit comprises a voltage divider circuit between an output of the bridge rectifier and an input to the PMU, wherein the voltage divider circuit is configured to determine a voltage ratio of the input voltage and determine a rectifier current output from the voltage ratio, wherein the PMU is configured to determine a rectifier power output with the rectifier current output, and wherein the MPPT threshold corresponds to a maximum value of the rectifier power output.

11. A method of harvesting energy, comprising:
sensing alternating current (AC) energy on a power line;
extracting the sensed AC energy from the power line;
converting the extracted AC energy into direct current (DC) energy;
supplying the DC energy as an input voltage to a power management unit (PMU);
comparing the input voltage to a maximum power point tracking (MPPT) threshold;
driving a load with the input voltage when the input voltage satisfies the MPPT threshold; and
driving the load with stored DC energy when the input voltage does not satisfy the MPPT threshold.

12. The method of claim 11, wherein driving the load with the input voltage comprises:
driving an output of the PMU with a first voltage signal from a boost regulator circuit of the PMU when the input voltage satisfies the MPPT threshold.

13. The method of claim 12, wherein driving the load with the stored DC energy comprises:
driving the output of the PMU with a second voltage signal from a low dropout linear regulator (LDO) circuit when the input voltage does not satisfy the MPPT threshold.

14. The method of claim 11, further comprising:
measuring an output of the PMU to determine a regulated output voltage;
determining whether the regulated output voltage exceeds a first threshold;
enabling a boost regulator circuit of the PMU to drive the output of the PMU when the regulator output voltage does not exceed the first threshold; and
disabling the boost regulator circuit from driving the output of the PMU when the regulator output voltage exceeds the first threshold, wherein the boost regulator circuit is disabled until the regulator output voltage is reduced to less than the first threshold.

15. The method of claim 14, wherein the PMU is configured to:
driving the output of the PMU with the boost regulator circuit when the regulator output voltage does not exceed the first threshold and exceeds a second threshold less than the first threshold; and
driving the output of the PMU with a low dropout linear regulator (LDO) circuit when the regulator output voltage does not exceed a third threshold less than the second threshold.

16. The method of claim 15, further comprising:
charging the LDO circuit with a first stored energy of an energy storage element when the first stored energy exceeds a second stored energy of a backup energy storage element; and
charging the LDO circuit with the second stored energy when the first stored energy does not exceed the second stored energy.

17. A system for energy harvesting, comprising:
means for sensing alternating current (AC) energy on a power line;
means for extracting the sensed AC energy from the power line;
means for converting the extracted AC energy into direct current (DC) energy;
means for supplying the DC energy as an input voltage to a power management unit (PMU);
means for comparing the input voltage to a maximum power point tracking (MPPT) threshold;
means for driving a load with the input voltage when the input voltage satisfies the MPPT threshold; and
means for driving the load with stored DC energy when the input voltage does not satisfy the MPPT threshold.

18. The system of claim 17, further comprising:
means for driving an output of the PMU with a first voltage signal from a boost regulator circuit of the PMU when the input voltage satisfies the MPPT threshold; and
means for driving the output of the PMU with a second voltage signal from a low dropout linear regulator (LDO) circuit when the input voltage does not satisfy the MPPT threshold.

19. The system of claim 18, further comprising:
means for driving the output of the PMU with the boost regulator circuit when a regulator output voltage of the PMU does not exceed a maximum boost threshold and exceeds a boost enable threshold less than the maximum boost threshold; and
means for driving the output of the PMU with the LDO circuit when the regulator output voltage does not exceed an LDO enable threshold less than the boost enable threshold.

20. The system of claim 19, further comprising:
means for charging the LDO circuit with a first stored energy from an energy storage element when the first stored energy of the energy storage element exceeds a second stored energy of a backup energy storage element; and
means for charging the LDO circuit with the second stored energy when the first stored energy does not exceed the second stored energy.
